(19) United States
(12) Patent Application Publication
(10) Pub. No.: US 2006/0239579 A1
(43) Pub. Date: Oct. 26, 2006

(54) Non Uniform Blending of Exposure and/or Focus Bracketed Photographic Images

(76) Inventor: Bradford Allison Ritter, Fort Collins, CO (US)

Correspondence Address: BRADFORD A. RITTER, 2619 MCKEAG DRIVE, FORT COLLINS, CO, 80526, US

(21) Appl. No.: 10/907,993

(22) Filed: Apr. 22, 2005

(51) Int. Cl. G06K 9/00; G06K 9/40; G09G 5/00

(52) U.S. Cl. 382/274; 382/167; 382/275; 345/629

(57) ABSTRACT

The present invention provides a method for the non-uniform blending of digital representations of photographic images. The method of the present invention is a computer program. In accordance with the method of the present invention, a pair of exposure or focus bracketed photographic images are blended together to produce a single image with the best characteristics of the original images. A pixel characteristic is chosen to control the blending of the two images. Each pixel in the pair of images is analyzed, producing a single scalar value for each pixel that represents the chosen characteristic. For each image the scalar values can optionally be smoothed. Smoothing consists of averaging the scalar values for a pixel with the scalar value for all pixels within a specified neighboring region. The scalar values for all pairs of pixels are then analyzed to calculate the maximum of (scalar1_value-scalar2_value) and the minimum of (scalar1_value-scalar2_value). The values scalar1_value and scalar2_value correspond to the calculated scalar values for a pixel pair according to the chosen pixel characteristic. The pixel intensities for each pair of pixels is optionally adjusted to a common value. The common intensity value for a pair of pixels is a function of the original intensities of the pixel pair. Finally, each pixel pair is blended according to an arbitrary blending function. The blending function is a function of the independent variables: (scalar1_value-scalar2_value) for the pixel pair to be blended; max(scalar1_value-scalar2_value) for all pixel pairs in the images to be blended; min(scalar1_value-scalar2_value) for all pixel pairs in the images to be blended.

### TECHNICAL FIELD OF THE INVENTION

The present invention generally relates to digital photographic image processing or editing and more specifically, to a method for blending multiple, exposure or focus, bracketed digital photographic images.

### BACKGROUND OF THE INVENTION

It is common practice to perform digital processing of photographic images. In some cases the digital processing procedure is performed after photographs have been acquired by a digital camera and subsequently transferred to a computer. Digital processing can also be performed on photographs acquired using film cameras by converting a print or negative image to a digital form by the use of a scanner. It is also common practice to perform digital processing of images acquired using a digital camera on the digital camera itself.

In the field of photography it has long been common practice to acquire multiple images of the same shot by employing a technique called bracketing. Bracketing, as a photographic term, means to collect multiple image of the same scene or object while adjusting the camera's settings between shots.

One form of bracketing, referred to as exposure bracketing, is performed by collect multiple images while adjusting the camera's settings between shots with the intent of capturing images with varying degrees of exposure. Another form of bracketing, referred to as focus bracketing, is performed by collecting multiple images while adjusting the focus distance between shots with the intent of focusing at different distances from the camera.

It has generally been the case that, after collecting multiple photographic images of a scene using any bracketing technique, the photographer would then choose a single image with the best exposure or focus settings for the most important object or area of the scene. The methods outlined in this invention enable the useful merging of two or more of these bracketed images. Acquiring multiple images with one form or another of bracketing is a way of collecting more information, or more accurate information, about a scene than can be acquired with any single set of camera settings. The useful merging of multiple bracketed images is a way of assembling more information into one digital image than can be accomplished with any single image acquired using a single set of camera settings. There are characteristics of the photographic process and common photographic equipment that support the premise that bracketing is a way of collecting additional information about a scene. Setting a camera's lens at a larger f-stop value will capture objects in a scene in focus over a greater depth of field. However, a lens' best optical performance is achieved by avoiding the extremes of its supported f-stop range. Collecting multiple images using multiple focus distances is a way of collecting more accurate information than is possible with a single high or maximum f-stop setting. Also, objects that are slightly under exposed in a photograph typically exhibit greater color saturation than objects that are over exposed. Collecting multiple images using multiple exposure settings is a way of collecting more accurate information about the color of objects than is possible with a single set camera settings. The method described by this invention provides a way of merging digital images as a way of blending, in a single digital image, more information, or more accurate information, than can be acquired with any single set of camera and lens settings.

### SUMMARY OF THE INVENTION

The present invention provides a method for blending two, focus or exposure bracketed, digital photographs. The form of the present invention is a software program suitable for operation on a computer or other digital device of sufficient capability. Certain digital cameras or flat bed scanning devices are examples of other such devices. The method of the present invention describes the blending of two digital photographic images, producing a single result image. It is reasonable to apply the method of the present invention to more than two images by applying the method to images two at a time. The photographic images that the method of the present invention is applied to are typically acquired by a digital camera using exposure or focus bracketing. It is also practical to apply the method of the present invention to images acquired by a film based camera after scanning the resulting print or negative with a suitable scanner device.

The two images to be blended using the method of the present invention are initially aligned so that common features are present at substantially similar pixel locations in the two digital images. There is sufficient technology in the field of digital processing to analyze images such that one or the other image can be modified to produce two images with sufficient alignment of common features.

A characteristic of a digital image pixel is then selected for controlling the proportions used when blending each pair of pixels. Such a pair of pixels consists of pixels selected from common pixel addresses of the two aligned images. The feature of a digital image pixel that can be used to control the blending include but is not limited to color saturation, hue and contrast, where contrast is a measure of the absolute difference in intensity between a pixel and its immediate neighbors. An evaluation step is performed in which all pixels in each of the two images are evaluated to arrive at a scalar representation of the selected characteristic. A smoothing pass can optionally be applied to each pixel's scalar value. Smoothing refers to a process of averaging the scalar values for a pixel with the scalar values of all pixels within a specified neighboring region. This smoothing operation is particularly useful when blending a pair of focus bracketed images based on the pixel characteristic of contrast.

The pixel scalar values for pixel pairs determined in the image evaluation step are then analyzed. Each pair of pixels is used to calculate values for the maximum of (pixel1_scalar-pixel2_scalar) and the minimum of (pixel1_scalar-pixel2_scalar) of all pairs of pixels in the two aligned images. For subsequent reference refer to these two values as max and min. For each pixel pair pixel1_scalar is the calculated scalar value for the pixel from image 1 and pixel2_scalar is the calculated scalar value for the pixel from image 2.

A function is specified to control the blending of pixel pairs. Substantial flexibility is provided in specifying the blending function. Constraints placed on this function are:

Pairs of pixels are blended in proportions that sum to a total of 1. For example, the function could specify that ½ of a pixel from image 1 is to be blended with ½ of the corresponding pixel from image 2. Or that ¼ of a pixel from image 1 is to be blended with ¾ of the corresponding pixel from image 2.

For a pair of pixels the specified blending function is a function of (these are referred to as the functions independent variables)
(pixel1_scalar-pixel2_scalar)
max
min

Examples of this function specification are (but not limited to):

Example 1:
If (pixel1_scalar-pixel2_scalar)>=0
   Blended_Pixel=pixel1
Else
   Blended_Pixel=pixel2

Example 2:
If (pixel1_scalar-pixel2_scalar)>=0
   Factor=(pixel1_scalar-pixel2_scalar)/max
   Blended_Pixel=Factor*pixel1+(1−factor)*pixel2
Else
   Factor=(pixel1_scalar-pixel2_scalar)/min
   Blended_Pixel=Factor*pixel2+(1−factor)*pixel1

Flexibility is supported in specifying the blending function. The choice of the above set of the blending function's independent variables facilitate the specification of a blending function with certain useful characteristics:

When pixel1_scalar is greater than pixel2_scalar it is usually advantageous to produce a Blended_Pixel using a greater proportion of pixel1 and a lessor proportion of pixel2. When pixel2_scalar is greater than pixel1_scalar it is usually advantageous to produce a Blended_Pixel using a greater proportion of pixel2 and a lessor proportion of pixel1.

Specifying max and min as independent variables to the blending function allows the specification of a smooth and continuous function over the range min . . . max. When (pixel1_scalar-pixel2_scalar) equals max it is the case that this is a pixel pair in which the pixel from image 1 has the greatest evaluated advantage over the pixel from image 2 for all pairs of pixels in the entire pair of images. It is often useful to specify a blending function that will create a Blended_Pixel in this case using very near 100% of the pixel from image 1. Conversely, when (pixel1_scalar-pixel2_scalar) equals min it is the case that this is a pixel pair in which the pixel from image 2 has the greatest evaluated advantage over the pixel from image 1 for all pairs of pixels in the entire pair of images. It is often useful to specify a blending function that will create a Blended_Pixel using very near 100% of the pixel from image 2. A flexible and arbitrary blending function provides for a non-uniform blending of two digital images.

For pairs of images collected using exposure bracketing it is often necessary to adjust the intensity of individual pairs of pixels to a common value immediately prior to blending. Each pixel's color and saturation is maintained, only the intensity is altered. The method of the present invention includes the optional adjustment of the intensity of pairs of pixel values. A single scalar value, Intensity_Scalar, for the entire pair of images, controls the choice of a final intensity for each pair.

Final_Intensity=Pixel1_Intensity+Intensity_Scalar*(Pixel2_Intensity−Pixel1_intensity)

What is claimed is:

1. A method for blending digital representations of two photographic images in proportions that vary from one pixel to another: logic that associates a scalar value with each pixel of each image; and logic that blends corresponding pixels as a function of the associated scalar values.

2. The method of claim 1, further comprising two images that are similar while varying in the exposure settings used at the time the photographs are acquired.

3. The method of claim 1, further comprising two images that are similar while varying in the focus distance used at the time the photographs are acquired.

4. The method of claim 1, further comprising scalar values associated with each pixel of each image that is a scalar representation of the pixel's color saturation.

5. The method of claim 1, further comprising scalar values associated with each pixel of each image that is a scalar representation of the pixel's hue.

6. The method of claim 1, further comprising scalar values associated with each pixel of each image that is a scalar representation of the pixel's contrast, where contrast is a measure of a pixel's intensity relative to neighboring pixels.

7. The method of claim 1, further comprising a blending function that is an arbitrary function of: (image1_scalar-image2_scalar) for each pair of pixels to be blended; the maximum of (image1−scalar-image2_scalar) for all pairs of pixels in the two images; the minimum of (image1−scalar-image2_scalar) for all pairs of pixels in the two images.

8. The method of claim 1, further comprising a smoothing pass on the scalar values associated with each pixel in each image prior to the blending operation; smoothing is the averaging of all pixel scalar values within a specified neighboring region.

9. The method of claim 1, further comprising the modification of the intensity of pairs of pixels to be blended, where the adjusted intensity is a function of the intensity of the two pixels to be blended.

10. A system comprising a system capable of blending the digital representations of two photographic images.

11. The system of claim 10, further embodied as a computer software program.

12. The system of claim 10, further comprising any digital processing device capable of effecting the instructions of said software program.
